(19) United States
(12) Patent Application Publication
(10) Pub. No.: US 2010/0207919 A1
(43) Pub. Date: Aug. 19, 2010

(54) DISPLAY DEVICE, AND ITS DRIVE CIRCUIT AND DRIVE METHOD

(76) Inventor: Junichi Sawahata, Osaka (JP)

Correspondence Address: HARNESS, DICKEY & PIERCE, P.L.C., P.O. BOX 8910, RESTON, VA, 20195, US

(21) Appl. No.: 12/734,148

(22) PCT Filed: Sep. 17, 2008
(86) PCT No.: PCT/JP2008/066697

§ 371 Date: Apr. 14, 2010

(30) Foreign Application Priority Data
Dec. 25, 2007 (JP) 2007-331952

(51) Int. Cl. G06F 3/038

(52) U.S. Cl. 345/209; 345/96

(57) ABSTRACT

An objective of the present invention is to prevent the occurrence of horizontal streaks in a screen of a display device that implements pseudo impulse display by performing black insertion. In a display device that implements pseudo impulse display by performing black insertion, a gate driver applies to each gate bus line a scanning signal including a pixel data write pulse (Pw) for writing pixel data to a pixel formation portion and black voltage application pulses (Pb) for writing a black voltage, based on a gate output control signal (GOE). Here, when the polarity of a polarity control signal (REV) is the same for two consecutive horizontal scanning periods, the gate output control signal (GOE) is maintained at a high level. When the gate output control signal (GOE) is at a high level, the gate driver inhibits a black voltage application pulse (Pb) from being generated in all the scanning signals.

### TECHNICAL FIELD

The present invention relates to a display device that implements pseudo impulse display, and a drive circuit and a drive method for the display device.

### BACKGROUND ART

In an impulse-type display device such as a CRT (Cathode Ray Tube), when taking a look at individual pixels, a light-on period during which an image is displayed and a light-off period during which an image is not displayed are alternately repeated. For example, when display of a moving image is performed, too, since a light-off period is inserted when a rewrite of an image for one screen is performed, human vision does not perceive an after-image of a moving object. Hence, the background and the object can be clearly distinguished from each other and accordingly a moving image is visually recognized without any unnatural feeling.

In contrast to this, in a hold-type display device such as a liquid crystal display device using TFTs (Thin Film Transistors), the luminances of individual pixels are determined by voltages held in their respective pixel capacitances. A holding voltage in a pixel capacitance is maintained for one frame period once rewritten. In this manner, in the hold-type display device, a voltage to be held in a pixel capacitance as pixel data is held once written, until the next rewrite. As a result, an image of each frame temporally approximates an image of its immediately preceding frame. By this, when a moving image is displayed, human vision perceives an after-image of a moving object. For example, as shown in FIG. 16, an after-image AI occurs in such a manner that an image OI representing a moving object leaves a trail (this after-image is hereinafter referred to as a “trailing after-image”).

In a hold-type display device such as an active matrix-type liquid crystal display device, a trailing after-image such as that described above occurs when displaying a moving image. Hence, conventionally, it is common practice to adopt impulse-type display devices for displays of television sets, etc., on which mainly moving image display is performed. However, in recent years, there have been strong demands for weight reduction and slimming down of displays of television sets, etc. Thus, for such displays, adoption of hold-type display devices, such as liquid crystal display devices, with which weight reduction and slimming down are easily achieved, has been rapidly promoted.

For a method for improving the above-described trailing after-image in hold-type display devices such as active matrix-type liquid crystal display devices, a method is known in which (pseudo) impulse display is implemented by inserting, in one frame period, a period during which black display is performed (hereinafter, referred to as “black insertion”), and so on. In addition, for a method for reducing power consumption, a method is known in which charge is shared between source bus lines by short-circuiting the source bus lines before pixel capacitances are charged (hereinafter, referred to as “charge sharing”) (for example, Japanese Patent Application Laid-Open No. 2007-102132). In addition, Japanese Patent Application Laid-Open No. 2007-192867 discloses an invention pertaining to a liquid crystal display device in which a charge sharing configuration is applied to a configuration for performing black insertion.

FIGS. 17A to 17E are signal waveform diagrams for a conventional liquid crystal display device in which a charge sharing configuration is applied to a configuration for performing black insertion. FIGS. 17A to 17E respectively show the waveforms of a polarity control signal REV for controlling the polarities of data signals, a short circuit control signal Csh for performing control of a short circuit between source bus lines, a data signal S(i) which is applied to a source bus line of an ith column, a scanning signal G(j) which is applied to a gate bus line of a jth row, and the luminance of a pixel formation portion arranged in the jth row and the ith column. In the liquid crystal display device, during a period during which the logical level of the short circuit control signal Csh is a high level, adjacent source bus lines are short-circuited. By this, during such a period, as shown in FIG. 17C, the value of the data signal S(i), i.e., the voltage of the source bus line of the ith column, reaches a voltage corresponding to black display (hereinafter, also simply referred to as a “black voltage”). When taking a look at the waveform of the scanning signal G(j) shown in FIG. 17D, a pulse for writing pixel data (hereinafter, referred to as a “pixel data write pulse”) Pw is generated during a period from time point t1 to time point t2. By this, at time point t2, the luminance of the pixel formation portion arranged in the jth row and the ith column reaches a luminance according to the value of the data signal S(i). Then, during a period from time point t3 after a lapse of a (⅔) frame period from time point t2, to time point t4, a pulse for performing black insertion (hereinafter, referred to as a “black voltage application pulse”) Pb is generated four times. Here, during a period during which a black voltage application pulse Pb is generated, as shown in FIG. 17C, the voltage of the source bus line is a black voltage. As a result, each time a black voltage application pulse Pb is generated, the luminance of the pixel formation portion arranged in the jth row and the ith column decreases (approaches a black level), as shown in FIG. 17E. In this manner, a period during which black display is performed is inserted in each frame period, to make an improvement in display quality at the time of moving image display on the liquid crystal display device.

[Patent Document 1] Japanese Patent Application Laid-Open No. 2007-102132

[Patent Document 2] Japanese Patent Application Laid-Open No. 2007-192867

### DISCLOSURE OF THE INVENTION

### Problems to be Solved by the Invention

However, in a liquid crystal display device such as that described above, a horizontal streak such as that shown in FIG. 18 (a line occurring in a direction in which gate bus lines extend) may be visually recognized on a screen. This will be described below with reference to FIGS. 19A to 19E. Conventionally, a liquid crystal display device that adopts a charge sharing scheme to reduce power consumption is configured such that, when the polarity of a data signal which is applied to a source bus line is the same for two consecutive horizontal scanning periods (a “previous horizontal scanning period” and a “subsequent horizontal scanning period”), adjacent source bus lines are not short-circuited during the subsequent horizontal scanning period. The reason for this is as follows; There is no need to remove charge accumulated in the source bus line when there is no change in the polarity of the data signal, and if the configuration is such that a write is performed after obtaining a black voltage (for the voltage of the source bus line), power consumption rather increases. Meanwhile, in some display devices, as shown in FIG. 19A, the polarity of a polarity control signal REV for controlling the polarities of data signals may be the same for two consecutive horizontal scanning periods near the timing (time point ta) at which switching between frame periods is performed. For example, in a liquid crystal display device that adopts one-line inversion drive, when the number of horizontal scanning periods during one frame period (also including a vertical blanking period) is an even number, the polarity of the polarity control signal REV is made the same for the last horizontal scanning period in a previous frame period (nth frame) and the first horizontal scanning period in a subsequent frame period ((n+1)th frame). In such a display device, adjacent source bus lines are not short-circuited during a period immediately after switching between frame periods is performed (e.g., a period from time point ta to time point tb in FIGS. 19A to 19E). Therefore, during such a period, as shown in FIG. 19D, the voltage of a source bus line does not reach a black voltage. However, as shown in FIG. 19C, there also exists a scanning signal in which a black voltage application pulse Pb is generated during such a period (here, it is assumed that the fourth black voltage application pulse Pb is generated in a scanning signal G(v) which is applied to a gate bus line of a vth row). By this, as shown in FIG. 19E, the luminance of a pixel formation portion arranged in the vth row and an ith column increases at and after time point ta, according to the value of a data signal S(i). As a result, sufficient black display is not performed for only those pixel formation portions arranged in the vth row and accordingly a horizontal streak such as that shown in FIG. 18 is visually recognized on a screen (display unit). Note that the aforementioned scanning signal is generated by a gate driver based on a gate output control signal GOE which is a signal generated by a display control circuit and which is a signal having a waveform such as that shown in FIG. 19B, etc.

Therefore, an object of the present invention is to prevent the occurrence of horizontal streaks on a screen in a display device that implements pseudo impulse display by performing black insertion.

### Means for Solving the Problems

A first aspect of the present invention is directed to an active matrix-type display device comprising:

a plurality of data signal lines for transmitting a plurality of data signals representing an image to be displayed;

a plurality of scanning signal lines intersecting the plurality of data signal lines;

a plurality of pixel formation portions arranged in a matrix form at respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected;

a data signal line drive circuit that receives a latch signal including pulses, each generated every horizontal scanning period, and a polarity control signal for determining a polarity of each data signal, and applies the plurality of data signals to the plurality of data signal lines such that the polarity of each data signal is reversed every predetermined cycle in each frame period, based on a logical level of the polarity control signal obtained at a time of a rise or a fall of a pulse of the latch signal;

a black voltage insertion circuit that brings voltages of the plurality of data signal lines to a voltage corresponding to black display only for a predetermined black voltage insertion period when polarities of the plurality of data signals are reversed, based on the latch signal and the polarity control signal, the black voltage insertion circuit being provided inside or external to the data signal line drive circuit;

a scanning signal line drive circuit that places each scanning signal line in a selected state, based on a predetermined output control signal which changes between a first logical level and a second logical level substantially in synchronization with timing of a rise and a fall of the pulses of the latch signal; and

an output control signal generation circuit for generating the output control signal, wherein

the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display,

during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal generation circuit maintains the output control signal at the first logical level during the subsequent horizontal scanning period, and

the scanning signal line drive circuit:
places each scanning signal line in the first selected state at least once in each frame period and places each scanning signal line in the second selected state a plurality of times in each frame period; and
does not place any of the plurality of scanning signal lines in the second selected state if the output control signal is at the first logical level.

According to a second aspect of the present invention, in the first aspect of the present invention,

the data signal line drive circuit applies the plurality of data signals to the plurality of data signal lines such that polarities of data signals applied to adjacent data signal lines, respectively, differ from each other, and

the black voltage insertion circuit brings the voltages of the plurality of data signal lines to a voltage corresponding to black display by short-circuiting the adjacent data signal lines.

According to a third aspect of the present invention, in the first aspect of the present invention,

the scanning signal line drive circuit receives a start pulse signal including: a first pulse having a first pulse width corresponding to a period for allowing each pixel formation portion to capture a voltage corresponding to the image to be displayed; and a second pulse having a second pulse width corresponding to a period for allowing each pixel formation portion to capture a voltage corresponding to the black display, and places each scanning signal line in the second selected state based on the second pulse of the start pulse signal and the output control signal, and

the second pulse width is a period corresponding to at least four horizontal scanning periods.

According to a fourth aspect of the present invention, in the third aspect of the present invention,

the scanning signal line drive circuit further receives a clock signal including pulses, each generated every horizontal scanning period, and places each scanning signal line in the first selected state based on the first pulse of the start pulse signal and the pulses of the clock signal.

A fifth aspect of the present invention is directed to a drive circuit for an active matrix-type display device including a plurality of data signal lines for transmitting a plurality of data signals representing an image to be displayed; a plurality of scanning signal lines intersecting the plurality of data signal lines; and a plurality of pixel formation portions arranged in a matrix format respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected, the drive circuit comprising:

a data signal line drive circuit that receives a latch signal including pulses, each generated every horizontal scanning period, and a polarity control signal for determining a polarity of each data signal, and applies the plurality of data signals to the plurality of data signal lines such that the polarity of each data signal is reversed every predetermined cycle in each frame period, based on a logical level of the polarity control signal obtained at a time of a rise or a fall of a pulse of the latch signal;

a black voltage insertion circuit that brings voltages of the plurality of data signal lines to a voltage corresponding to black display only for a predetermined black voltage insertion period when polarities of the plurality of data signals are reversed, based on the latch signal and the polarity control signal, the black voltage insertion circuit being provided inside or external to the data signal line drive circuit;

a scanning signal line drive circuit that places each scanning signal line in a selected state, based on a predetermined output control signal which changes between a first logical level and a second logical level substantially in synchronization with timing of a rise and a fall of the pulses of the latch signal; and

an output control signal generation circuit for generating the output control signal, wherein

the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display,

during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal generation circuit maintains the output control signal at the first logical level during the subsequent horizontal scanning period, and

the scanning signal line drive circuit:
places each scanning signal line in the first selected state at least once in each frame period and places each scanning signal line in the second selected state a plurality of times in each frame period; and
does not place any of the plurality of scanning signal lines in the second selected state if the output control signal is at the first logical level.

In addition, variants that are grasped by referring to the embodiment and the drawings in the fifth aspect of the present invention are considered to be means for solving the problems.

A ninth aspect of the present invention is directed to a drive method for an active matrix-type display device including a plurality of data signal lines for transmitting a plurality of data signals representing an image to be displayed; a plurality of scanning signal lines intersecting the plurality of data signal lines; and a plurality of pixel formation portions arranged in a matrix form at respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected, the drive method comprising:

a data signal line driving step of receiving a latch signal including pulses, each generated every horizontal scanning period, and a polarity control signal for determining a polarity of each data signal, and applying the plurality of data signals to the plurality of data signal lines such that the polarity of each data signal is reversed every predetermined cycle in each frame period, based on a logical level of the polarity control signal obtained at a time of a rise or a fall of a pulse of the latch signal;

a black voltage inserting step of bringing voltages of the plurality of data signal lines to a voltage corresponding to black display only for a predetermined black voltage insertion period when polarities of the plurality of data signals are reversed, based on the latch signal and the polarity control signal;

a scanning signal line driving step of placing each scanning signal line in a selected state, based on a predetermined output control signal which changes between a first logical level and a second logical level substantially in synchronization with timing of a rise and a fall of the pulses of the latch signal; and

an output control signal generating step of generating the output control signal, wherein

the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display,

in the output control signal generating step, during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal is maintained at the first logical level during the subsequent horizontal scanning period, and

in the scanning signal line driving step:
each scanning signal line is placed in the first selected state at least once in each frame period and each scanning signal line is placed in the second selected state a plurality of times in each frame period; and
none of the plurality of scanning signal lines is placed in the second selected state if the output control signal is at the first logical level.

In addition, variants that are grasped by referring to the embodiment and the drawings in the ninth aspect of the present invention are considered to be means for solving the problems.

### EFFECTS OF THE INVENTION

According to the first aspect of the present invention, in each display line, a write for essential image display and a write for black insertion are performed. The polarity of a data signal which is provided to a data signal line is determined based on the polarity control signal. At the time of reversal of the polarity of the data signal, application of a black voltage to the data signal line is performed. On the other hand, when the polarity of the data signal is not reversed, i.e., when the logical level of the polarity control signal is the same for two consecutive horizontal scanning periods, the voltage of the data signal line is maintained at a voltage (a voltage for essential image display) other than the black voltage. If the logical level of the polarity control signal is the same for two consecutive horizontal scanning periods, then the output control signal generation circuit maintains the logical level of the output control signal at the first logical level. In addition, if the logical level of the output control signal is the first logical level, then the scanning signal line drive circuit does not place any of the scanning signal lines in a selected state for black insertion. Hence, when the logical level of the polarity control signal is the same for two consecutive horizontal scanning periods, none of the scanning signal lines is placed in the selected state for black insertion. By this, for example, when the polarity of a data signal is the same for two consecutive horizontal scanning periods at the time of switching between frame periods, on a pixel formation portion on which a write for black insertion is to be performed, a write of a voltage other than the black voltage is not performed. By the above, while the occurrence of horizontal streaks on a screen is prevented, the display performance of moving images can be improved by implementing pseudo impulse display.

According to the second aspect of the present invention, in a display device that adopts a charge sharing configuration to perform black insertion, as with the first aspect of the present invention, while the occurrence of horizontal streaks on a screen is prevented, the display performance of moving images can be improved by implementing pseudo impulse display.

According to the third aspect of the present invention, the second pulse width of the start pulse signal corresponding to a period during which black insertion is performed corresponds to at least four horizontal scanning periods. Thus, for example, even if a write for black insertion is not performed at the time of switching between frame periods, a write for black insertion is performed at least three times for each pixel formation portion. By this, while sufficient black insertion in each pixel formation portion is ensured, the occurrence of horizontal streaks on a screen is prevented.

According to the fourth aspect of the present invention, the black insertion rate can be set to any rate and, as with the third aspect of the present invention, while sufficient black insertion in each pixel formation portion is ensured, the occurrence of horizontal streaks on a screen is prevented.

### BRIEF DESCRIPTION OF THE DRAWINGS

FIGS. 1A to 1M are signal waveform diagrams for describing the actions of a liquid crystal display device according to an embodiment of the present invention.

FIG. 2 is a block diagram showing a configuration of the liquid crystal display device according to the embodiment, together with an equivalent circuit of a display unit thereof.

FIGS. 3A to 3D are signal waveform diagrams in the embodiment.

FIG. 4 is a block diagram showing a configuration of a source driver in the embodiment.

FIG. 5 is a logic circuit diagram showing a configuration of a short circuit control signal generating unit in the embodiment.

FIGS. 6A to 6E are signal waveform diagrams for describing the operation of the short circuit control signal generating unit in the embodiment.

FIG. 7 is a circuit diagram showing a configuration of a source output unit in the embodiment.

FIG. 8 is a logic circuit diagram showing a configuration of a gate output control signal waveform adjustment circuit in the embodiment.

FIGS. 9A to 9F are signal waveform diagrams for describing the operation of the gate output control signal waveform adjustment circuit in the embodiment.

FIG. 10 is a block diagram showing a configuration of a gate driver in the embodiment.

FIG. 11 is a diagram showing a configuration of a gate driver IC chip in the embodiment.

FIGS. 12A to 12H are signal waveform diagrams for describing output signals from a shift register in the gate driver IC chip in the embodiment.

FIG. 13 is a diagram for describing a scanning signal which is outputted based on an output signal from a kth stage of the shift register in the embodiment.

FIGS. 14A to 14G are signal waveform diagrams for describing actions in the embodiment.

FIGS. 15A to 15E are signal waveform diagrams for describing effects in the embodiment.

FIG. 16 is a diagram for describing a problem occurring in moving image display in a conventional example.

FIGS. 17A to 17E are signal waveform diagrams for a conventional liquid crystal display device in which a charge sharing configuration is applied to a configuration for performing black insertion.

FIG. 18 is a diagram for describing a horizontal streak occurring in a display unit in a conventional example.

FIGS. 19A to 19E are signal waveform diagrams for describing the occurrence of a horizontal streak in the conventional example.

### DESCRIPTION OF THE REFERENCE NUMERALS

37 and 51: D FLIP-FLOP CIRCUIT
38 and 52: XOR CIRCUIT
39, 43, 44, and 46: AND CIRCUIT
40: SHIFT REGISTER
42, 45, and 53: OR CIRCUIT
47: GATE OUTPUT UNIT
100: DISPLAY UNIT
200: DISPLAY CONTROL CIRCUIT
300: SOURCE DRIVER (DATA SIGNAL LINE DRIVE CIRCUIT)
302: DATA SIGNAL GENERATING UNIT
304: SHORT CIRCUIT CONTROL SIGNAL GENERATING UNIT
306: SOURCE OUTPUT UNIT
400: GATE DRIVER (SCANNING SIGNAL LINE DRIVE CIRCUIT)
411 to 41q: GATE DRIVER IC CHIP
SLi: SOURCE BUS LINE (DATA SIGNAL LINE) (i=1 to n)
GLj: GATE BUS LINE (SCANNING SIGNAL LINE) (j=1 to m)
DA: DIGITAL IMAGE SIGNAL
SSP: SOURCE START PULSE SIGNAL
SCK: SOURCE CLOCK SIGNAL
GSP: GATE START PULSE SIGNAL
GCK: GATE CLOCK SIGNAL
Csh: SHORT CIRCUIT CONTROL SIGNAL
GOE: GATE OUTPUT CONTROL SIGNAL
GOEpre: PRE-ADJUSTMENT GATE OUTPUT CONTROL SIGNAL
Qk: OUTPUT SIGNAL FROM SHIFT REGISTER (k=1 to p)
S(i): DATA SIGNAL (i=1 to n)
G(j): SCANNING SIGNAL (j=1 to m)
Pw: PIXEL DATA WRITE PULSE
Pb: BLACK VOLTAGE APPLICATION PULSE

### BEST MODE FOR CARRYING OUT THE INVENTION

An embodiment of the present invention will be described below with reference to the accompanying drawings.

<1. Overall Configuration and Outline of Operation>

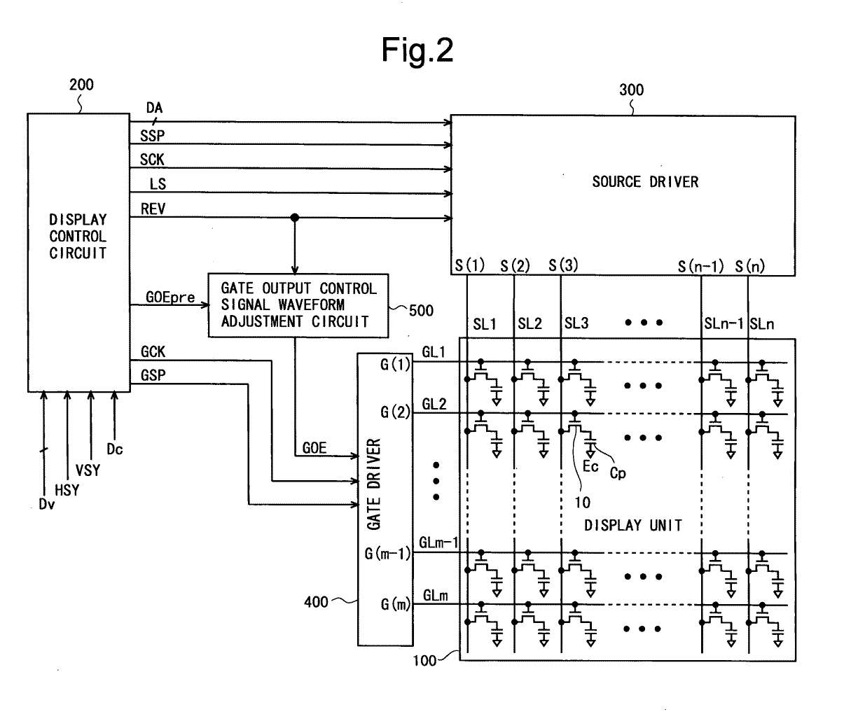

FIG. 2 is a block diagram showing a configuration of a liquid crystal display device according to the present embodiment, together with an equivalent circuit of a display unit thereof. The liquid crystal display device includes a source driver 300 serving as a data signal line drive circuit; a gate driver 400 serving as a scanning signal line drive circuit; an active matrix-type display unit 100; a display control circuit 200 for controlling the source driver 300 and the gate driver 400; and a gate output control signal waveform adjustment circuit 500 for adjusting the waveform of a gate output control signal which controls the operation of the gate driver 400.

The display unit 100 of the liquid crystal display device includes a plurality of (m) gate bus lines GL1 to GLm serving as scanning signal lines; a plurality of (n) source bus lines SL1 to SLn serving as data signal lines and intersecting the gate bus lines GL1 to GLm, respectively; and a plurality of (m×n) pixel formation portions which are respectively provided at intersections of the gate bus lines GL1 to GLm and the source bus lines SL1 to SLn. These pixel formation portions are arranged in a matrix form, configuring a pixel array. Each pixel formation portion is composed of a TFT 10 which is a switching element having a gate terminal connected to a gate bus line GLj passing through a corresponding intersection and having a source terminal connected to a source bus line SLi passing through the intersection; a pixel electrode connected to a drain terminal of the TFT 10; a common electrode Ec which is a counter electrode provided so as to be shared among the plurality of pixel formation portions; and a liquid crystal layer provided so as to be shared among the plurality of pixel formation portions, and sandwiched between the pixel electrode and the common electrode Ec. Then, by a liquid crystal capacitance formed by the pixel electrode and the common electrode Ec, a pixel capacitance Cp is formed. Note that although normally an auxiliary capacitance is provided in parallel with the liquid crystal capacitance in order to securely hold a voltage in the pixel capacitance, the auxiliary capacitance is not directly related to the present invention and thus the description and graphic representation thereof are omitted.

A potential according to an image to be displayed is provided to a pixel electrode of each pixel formation portion by the source driver 300 and the gate driver 400 which operate in a manner described later. In addition, a predetermined potential is provided to the common electrode Ec by a predetermined power supply circuit. By this, a voltage according to a potential difference between the pixel electrode and the common electrode Ec is applied to a liquid crystal, and by the voltage application the amount of light transmission through the liquid crystal layer is controlled, whereby image display is performed. Note that a sheet polarizer is used to control the amount of light transmission by voltage application to the liquid crystal layer and in the liquid crystal display device in the present embodiment a sheet polarizer is disposed so as to obtain normally black.

The display control circuit 200 receives, from an external signal source, a digital video signal. Dv representing an image to be displayed, a horizontal synchronizing signal HSY and a vertical synchronizing signal VSY for the digital video signal Dv, and a control signal Dc for controlling a display operation. Based on the signals Dv, HSY, VSY, and Dc, the display control circuit 200 generates and outputs a digital image signal DA corresponding to the digital video signal Dv, and a source start pulse signal SSP, a source clock signal SCK, a latch strobe signal (latch signal) LS, a polarity control signal REV, a gate start pulse signal GSP, a gate clock signal GCK, and a gate output control signal GOEpre which are used to control the timing of image display on the display unit 100. Note that the gate output control signal GOEpre outputted from the display control circuit 200 is subjected to a waveform adjustment, as will be described later, and thus the signal GOEpre is hereinafter also referred to as a “pre-adjustment gate output control signal”.

Of the above-described signals generated by the display control circuit 200, the digital image signal DA, the source start pulse signal SSP, the source clock signal SCK, and the latch strobe signal LS are inputted to the source driver 300, the gate start pulse signal GSP and the gate clock signal GCK are inputted to the gate driver 400, the polarity control signal REV is inputted to the source driver 300 and the gate output control signal waveform adjustment circuit 500, and the pre-adjustment gate output control signal GOEpre is inputted to the gate output control signal waveform adjustment circuit 500.

The gate output control signal waveform adjustment circuit 500 receives the pre-adjustment gate output control signal GOEpre outputted from the display control circuit 200 and outputs a signal obtained by adjusting (altering) the waveform of the signal GOEpre, as a gate output control signal GOE to be provided to the gate driver 400. Note that in the present embodiment an output control signal generation circuit is implemented by the gate output control signal waveform adjustment circuit 500.

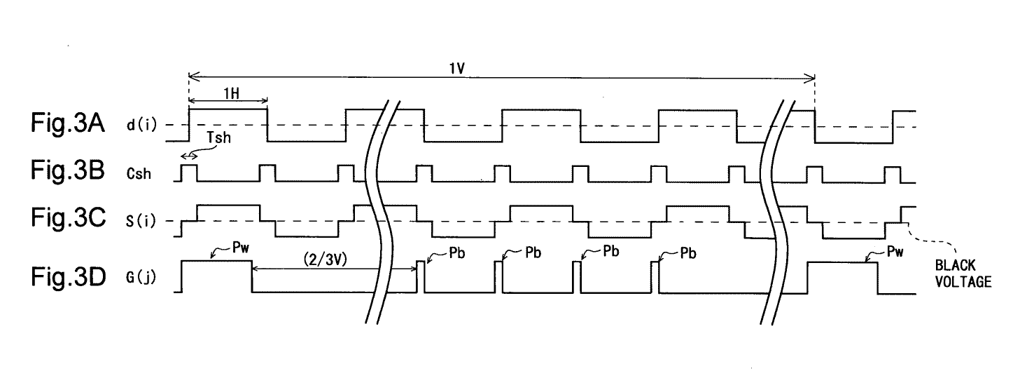

Based on the digital image signal DA, the source start pulse signal SSP, the source clock signal SCK, the latch strobe signal LS, and the polarity control signal REV, the source driver 300 sequentially generates data signals S(1) to S(n) every horizontal scanning period, as analog voltages corresponding to pixel values for respective lines of an image represented by the digital image signal DA. Then, the source driver 300 applies the data signals S(1) to S(n) to the source bus lines SL1 to SLn, respectively. The source driver 300 in the present embodiment adopts a drive scheme in which the data signals S(1) to S(n) are outputted such that the polarity of a voltage applied to the liquid crystal layer is reversed every frame period and is also reversed for each gate bus line and each source bus line in each frame, i.e., a dot inversion drive scheme. Therefore, the source driver 300 reverses the polarities of voltages applied to the source bus lines SL1 to SLn for each source bus line and reverses the polarity of a voltage of a data signal S(i) applied to each source bus line SLi every horizontal scanning period (see FIG. 3C).

Based on the gate start pulse signal GSP, the gate clock signal GCK, and the gate output control signal GOE, the gate driver 400 sequentially selects each of the gate bus lines GL1 to GLm for substantially one horizontal scanning period in each frame period (each vertical scanning period), to write the data signals S(1) to S(n) in the pixel capacitances of the respective pixel formation portions, and selects a gate bus line GLj only for a predetermined period upon reversal of the polarity of a data signal S(i) to perform black insertion (j=1 to m). Specifically, as shown in FIG. 3D, during one frame period (1V), one pixel data write pulse Pw and four black voltage application pulses Pb which successively appear at intervals of one horizontal scanning period (1H) are generated for each scanning signal G(j). The period between the pixel data write pulse Pw and a black voltage application pulse Pb which is the first one to appear after the pixel data write pulse Pw is a (⅔) frame period. In the present embodiment, the state of a gate bus line to which a scanning signal having a pixel data write pulse. Pw generated therein is applied corresponds to a first selected state and the state of a gate bus line to which a scanning signal having a black voltage application pulse Pb generated therein is applied corresponds to a second selected state.

Note that the following description is made assuming that the polarity of the above-described polarity control signal REV may be the same for two consecutive horizontal scanning periods near the timing at which switching between frame periods is performed (timing at which switching from an nth frame to an (n+1)th frame is performed) (e.g., the polarity may be a negative polarity during two consecutive horizontal scanning periods). Note also that description is made assuming that the period during which the fourth black voltage application pulse Pb is to be generated for a scanning signal G(v) which is applied to a gate bus line GLv of a with row corresponds to a period immediately after the timing at which switching between frame periods is performed.

<2. Configuration and Operation of the Source Driver>

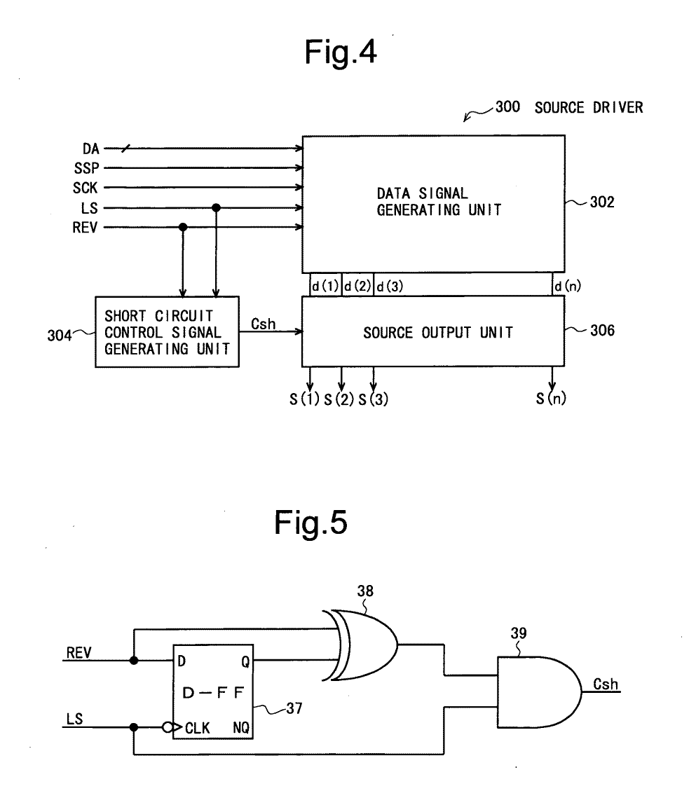

FIG. 4 is a block diagram showing a configuration of the source driver 300 in the present embodiment. The source driver 300 is configured by a data signal generating unit 302, a short circuit control signal generating unit 304, and a source output unit 306. The data signal generating unit 302 generates analog voltage signals d(1) to d(n) for the source bus lines SL1 to SLn, respectively, from a digital image signal DA, based on a source start pulse signal SSP, a source clock signal SCK, a latch strobe signal LS, and a polarity control signal REV. Note that the configuration of the data signal generating unit 302 is the same as that in conventional source drivers and thus description thereof is omitted.

The short circuit control signal generating unit 304 generates a short circuit control signal Csh for controlling whether to short-circuit adjacent source bus lines, based on the latch strobe signal LS and the polarity control signal REV, and outputs the short circuit control signal Csh. The source output unit 306 receives the analog voltage signals d (1) to d(n) which are generated based on the digital image signal DA, and impedance-converts the analog voltage signals d(1) to d(n) and thereby generates data signals S(1) to S(n) to be transmitted through the source bus lines SL1 to SLn, and outputs the data signals S(1) to S(n). In addition, in the source output unit 306 charge sharing is performed based on the short circuit control signal Csh, to reduce power consumption. Note that in the present embodiment a black voltage insertion circuit is implemented by the short circuit control signal generating unit 304 and the source output unit 306. The configuration and operation of the short circuit control signal generating unit 304 and the configuration and operation of the source output unit 306 will be described in detail below.

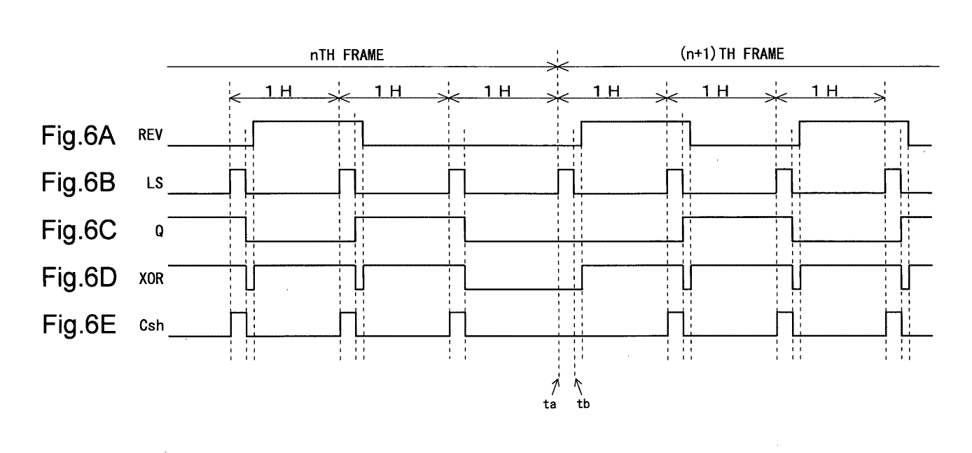

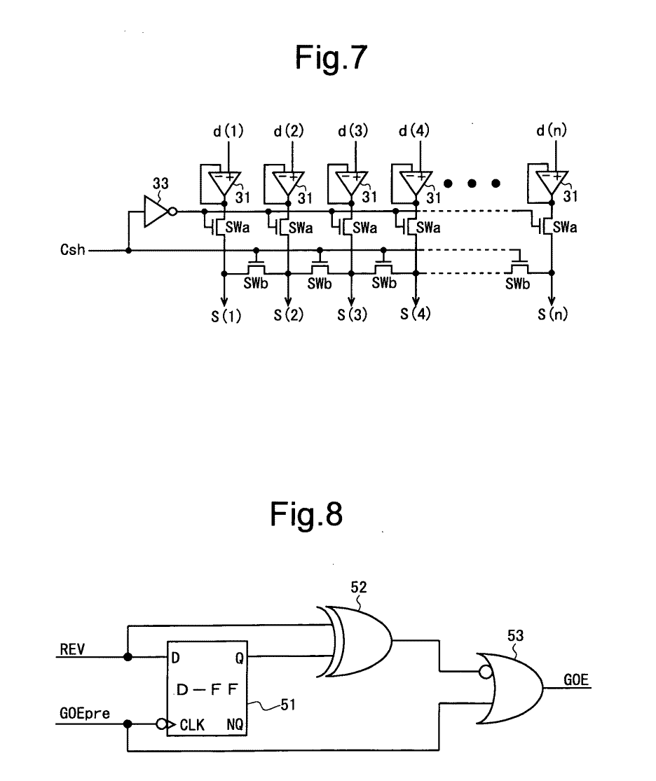

FIG. 5 is a logic circuit diagram showing a configuration of the short circuit control signal generating unit 304. Also, FIGS. 6A to 6E are signal waveform diagrams for describing the operation of the short circuit control signal generating unit 304. The short circuit control signal generating unit 304 is configured by a D flip-flop circuit 37, an XOR circuit 38, and an AND circuit 39. A polarity control signal REV having a waveform such as that shown in FIG. 6A is inputted into a D input terminal of the D flip-flop circuit 37 and a latch strobe signal LS having a waveform such as that shown in FIG. 6B is inputted into a clock input terminal. A signal indicating a logical value of the polarity control signal REV obtained at the time of a fall of the latch strobe signal LS is outputted from a Q output terminal of the D flip-flop circuit 37. Hence, an output signal having a waveform such as that shown in FIG. 6C is outputted from the Q output terminal of the D flip-flop circuit 37. The XOR circuit 38 outputs a signal indicating an exclusive OR of the polarity control signal REV and the output signal from the Q output terminal of the D flip-flop circuit 37. Thus, a signal having a waveform such as that shown in FIG. 6D is outputted from the XOR circuit 38. The AND circuit 39 outputs a signal indicating a logical product of the output signal from the XOR circuit 38 and the latch strobe signal LS, as a short circuit control signal Csh. Thus, the short circuit control signal Csh having a waveform such as that shown in FIG. 6E is outputted from the AND circuit 39. Then, the short circuit control signal Csh is provided to the source output unit 306 shown in FIG. 7.

FIG. 7 is a circuit diagram showing a configuration of the source output unit 306. The source output unit 306 has n output buffers 31 as voltage followers for generating data signals S(1) to S(n) by impedance-converting analog voltage signals d(1) to d(n). A first MOS transistor SWa serving as a switching element is connected to an output terminal of each buffer 31, and a data signal S(i) from each buffer 31 is outputted from an output terminal of the source driver 300 through the first MOS transistor SWa (i=1, 2, . . . n). In addition, adjacent output terminals of the source driver 300 are connected to each other by a second MOS transistor SWb serving as a switching element (by this, adjacent source bus lines are connected to each other by the second MOS transistor SWb). Then, the short circuit control signal Csh is provided to a gate terminal of the second MOS transistor SWb provided between these output terminals. An output signal from an inverter 33, i.e., a logical inverse signal of the short circuit control signal Csh, is provided to a gate terminal of the first MOS transistor SWa connected to the output terminal of each buffer 31.

Therefore, since, when the short circuit control signal Csh is at a low level, the first MOS transistors SWa are turned on (placed in a conduction state) and the second MOS transistors SWb are turned off (placed in a cutoff state), data signals from the buffers 31 are outputted from the source driver 300 through the first MOS transistors SWa. On the other hand, since, when the short circuit control signal Csh is at a high level, the first MOS transistors SWa are turned off (placed in a cutoff state) and the second MOS transistors SWb are turned on (placed in a conduction state), data signals from the buffers 31 are not outputted (i.e., application of data signals S(1) to S(n) to the source bus lines SL1 to SLn is interrupted) and adjacent source bus lines in the display unit 100 are short-circuited through a second MOS transistor SWb.

Meanwhile, in the present embodiment, as can be grasped from FIG. 6E, a pulse of the short circuit control signal Csh is not generated during a period (a period from time point to to time point tb) immediately after the timing at which switching between frame periods is performed. As such, when the polarity of the polarity control signal REV is maintained at the time of switching between frame periods, the short circuit control signal Csh is maintained at a low level. Hence, a short circuit between adjacent source bus lines does not take place during the period immediately after the timing at which switching between frame periods is performed.

In the source driver 300 in the present embodiment, an analog voltage signal d(i) whose polarity is reversed every horizontal scanning period (1H) is generated by the data signal generating unit 302 (see FIG. 3A) and a short circuit control signal Csh which is at a high level only for a predetermined period (a short period of about one horizontal blanking period) Tsh at the time of reversal of the polarity of each analog voltage signal d(i) is generated by the short circuit control signal generating unit 304 (the period Tsh during which the short circuit control signal Csh is at a high level is hereinafter referred to as a “short circuit period”) (see FIG. 3B). As described above, when the short circuit control signal Csh is at a low level each analog voltage signal d(i) is outputted as a data signal S(i), and when the short circuit control signal Csh is at a high level adjacent source bus lines are short-circuited. Then, in the present embodiment, since dot inversion drive is adopted, the voltages of adjacent source bus lines have opposite polarities, and moreover, the absolute values thereof are substantially equal to each other. Thus, the value of each data signal S(i), i.e., the voltage of each source bus line SLi, reaches a voltage corresponding to black display during the short circuit period Tsh. Note that the configuration in which the voltages of each source bus line is thus made to be substantially equal to the black voltage by short-circuiting adjacent source bus lines at the time of reversal of the polarity of data signals is proposed conventionally as a means for reducing power consumption and thus is not limited to that shown in FIG. 7. Note that in the present embodiment the short circuit period Tsh corresponds to a black voltage insertion period.

<3. Configuration and Operation of the Gate Output Control Signal Waveform Adjustment Circuit>

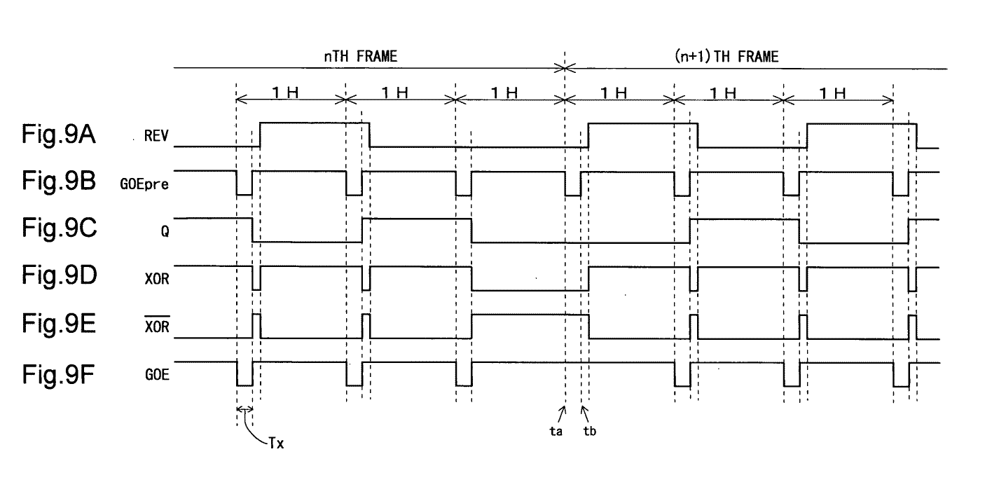

FIG. 8 is a logic circuit diagram showing a configuration of the gate output control signal waveform adjustment circuit 500. Also, FIGS. 9A to 9F are signal waveform diagrams for describing the operation of the gate output control signal waveform adjustment circuit 500. The gate output control signal waveform adjustment circuit 500 is configured by a D flip-flop circuit 51, an XOR circuit 52, and an OR circuit 53. A polarity control signal REV having a waveform such as that shown in FIG. 9A is inputted into a D input terminal of the D flip-flop circuit 51 and a pre-adjustment gate output control signal GOEpre having a waveform such as that shown in FIG. 9B is inputted into a clock input terminal. A signal indicating a logical value of the polarity control signal REV obtained at the time of a rise of the pre-adjustment gate output control signal GOEpre is outputted from a Q output terminal of the D flip-flop circuit 51. Hence, a signal having a waveform such as that shown in FIG. 9C is outputted from the Q output terminal of the D flip-flop circuit 51. The XOR circuit 52 outputs a signal indicating an exclusive OR of the polarity control signal REV and the output signal from the Q output terminal of the D flip-flop circuit 51. Thus, a signal having a waveform such as that shown in FIG. 9D is outputted from the XOR circuit 52. The OR circuit 53 outputs a signal indicating a logical sum of a logical inverse signal of the output signal from the XOR circuit 52, i.e., a signal having a waveform shown in FIG. 9E, and the pre-adjustment gate output control signal GOEpre, as a gate output control signal GOE. Thus, the gate output control signal GOE having a waveform such as that shown in FIG. 9F is outputted from the OR circuit 53. Then, the gate output control signal GOE is provided to the gate driver 400.

Here, as can be grasped from FIGS. 9B to 9F, although the pre-adjustment gate output control signal GOEpre is at a low level (second logical level) every horizontal scanning period only for a predetermined period Tx, the gate output control signal GOE (after waveform adjustment) is maintained at a high level (first logical level) during a period from time point ta to time point tb. As such, when the polarity of the polarity control signal REV is maintained at the time of switching between frame periods, the gate output control signal GOE which is provided to the gate driver 400 is maintained at a high level. Then, based on the gate output control signal GOE having such a waveform, black voltage application pulses Pb for each scanning signal are generated in the gate driver 400 in a manner described later.

<4. Configuration and Operation of the Gate Driver>

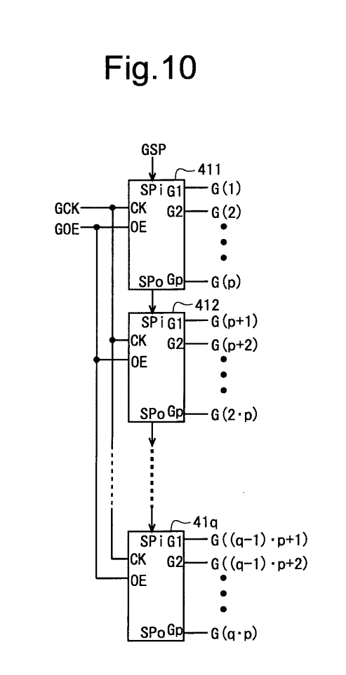

FIG. 10 is a block diagram showing a configuration of the gate driver 400 in the present embodiment. The gate driver 400 is composed of a plurality of (q) gate driver IC (Integrated Circuit) chips 411, 412, . . . 41q, each including a shift register and serving as a partial circuit.

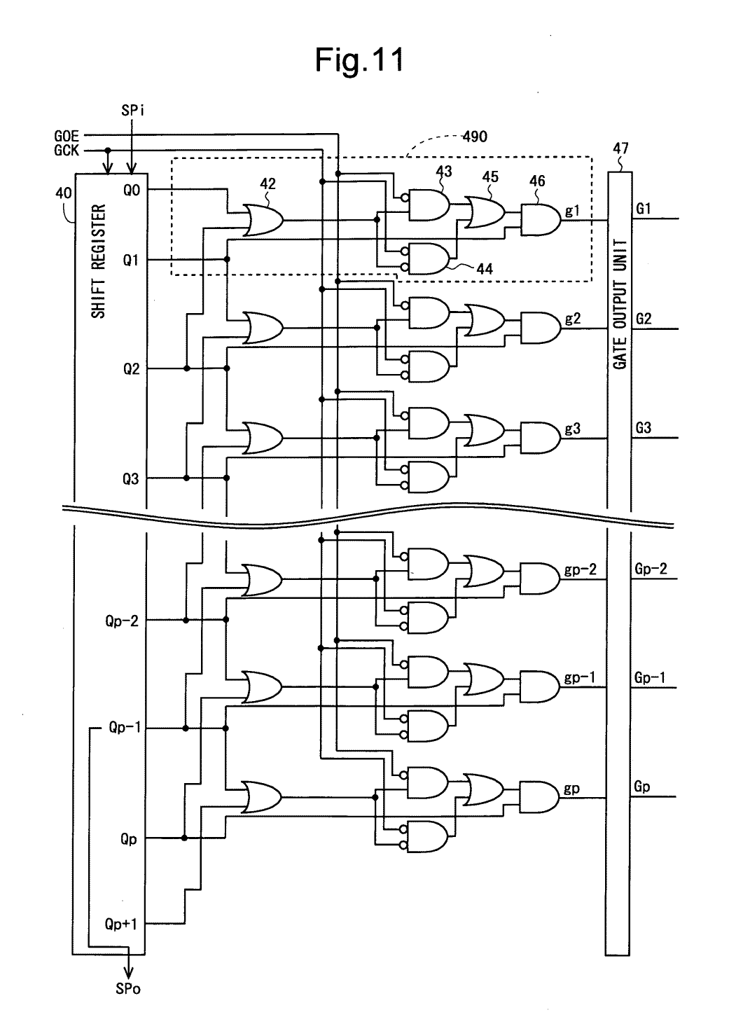

As shown in FIG. 11, each gate driver IC chip includes a shift register 40, and a first OR circuit 42, a first AND circuit 43, a second AND circuit 44, a second OR circuit 45, and a third AND circuit 46 which are provided for each stage of the shift register 40, and a gate output unit 47 that outputs scanning signals G1 to Gp, based on output signals g1 to gp from the third AND circuits 46. The shift register 40 has (p+2) stages from the 0th stage to a (p+1)th stage. Note that those components included in a dashed line area denoted by reference numeral 490 in FIG. 11 are components provided for the first stage of the shift register 40.

Each gate driver IC chip receives a gate clock signal GCK, a gate output control signal GOE, and a start pulse signal SPi which is based on a gate start pulse signal GSP. The start pulse signal SPi and the gate clock signal GCK are inputted into the shift register 40. The shift register 40 sequentially transfers, based on the signals SPi and GCK, a pulse included in the start pulse signal SPi from an input terminal to an output terminal. In response to the transferring of the pulse, pulses for output signals Q0 to Qp+1 from the shift register 40 are generated.

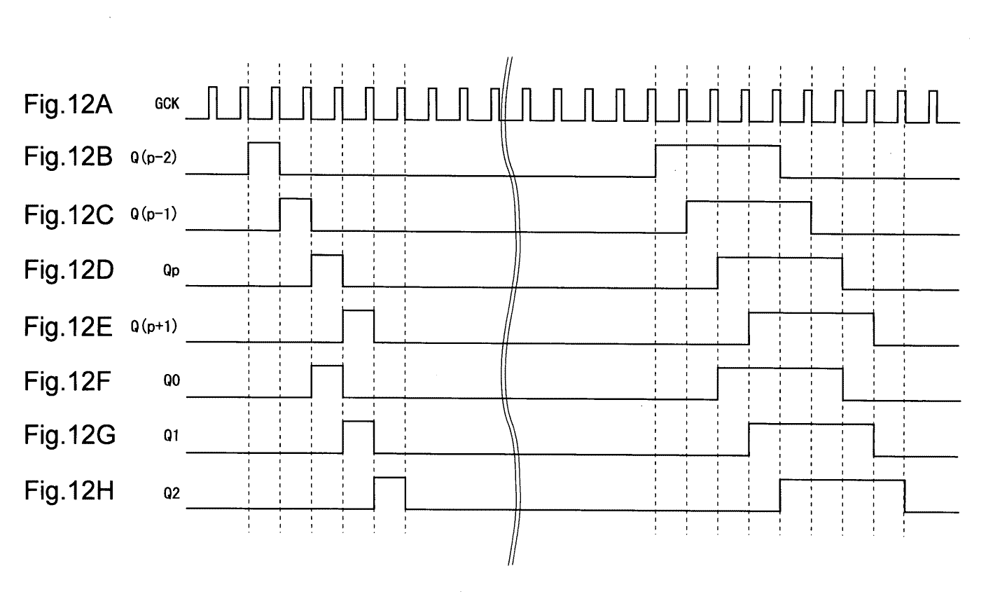

Meanwhile, the gate driver 400 in the present embodiment is implemented by, as shown in FIG. 10, cascade-connecting the plurality of (q) gate driver IC chips 411 to 41q of the above-described configuration. Namely, the configuration is such that the shift registers 40 in the gate driver IC chips 411 to 41q form one shift register (the shift registers thus formed by cascade connection are hereinafter referred to as “coupled shift registers”). Note that, as shown in FIG. 11, an output terminal of a (p−1)th stage of a shift register in each gate driver IC chip is connected to an input terminal (an input terminal for the start pulse signal SPi) of a shift register in its subsequent gate driver IC chip. Hence, as shown in FIGS. 12A to 12H, an output signal Qp from a pth stage of a shift register in an rth gate driver IC chip (of the cascade-connected gate driver IC chips) and an output signal Q0 from the 0th stage of a shift register in an (r+1) th gate driver IC chip have the same waveform, and an output signal Qp+1 from a (p+1)th stage of the shift register in the rth gate driver IC chip and an output signal Q1 from the first stage of the shift register in the (r+1)th gate driver IC chip have the same waveform.

For an output signal Q0 and an output signal Qp+1 which are outputted from a shift register 40 in each gate driver IC chip, their corresponding scanning signals are not outputted from a gate output unit 47. Note that a gate start pulse signal GSP is inputted into an input terminal of a shift register in the first gate driver IC chip 411 from the display control circuit 200, and an output terminal of a (p−1)th stage of a shift register in the last gate driver IC chip 41q is not connected to an external source.

Next, a detailed circuit configuration between the shift register 40 and the gate output unit 47 in the gate driver IC chip will be described. Note that in the following a component provided for each stage of the shift register 40 is referred to as “ . . . in each stage” (e.g., a “first OR circuit in each stage”). A first OR circuit 42 in each stage outputs a signal indicating a logical sum of an output signal from a preceding stage of the shift register 40 and an output signal from a subsequent stage of the shift register 40. A first AND circuit 43 in each stage outputs a signal indicating a logical product of a logical inverse signal of the gate output control signal GOE and the output signal from the first OR circuit 42 in the stage. A second AND circuit 44 in each stage outputs a signal indicating a logical product of a logical inverse signal of the gate clock signal GCK and a logical inverse signal of the output signal from the first OR circuit 42 in the stage. A second OR circuit 45 in each stage outputs a signal indicating a logical sum of the output signal from the first AND circuit 43 in the stage and the output signal from the second AND circuit 44 in the stage. A third AND circuit 46 in each stage outputs a signal indicating a logical product of the output signal from the second OR circuit 45 in the stage and an output signal from the stage of the shift register 40.

By thus configuring the gate driver 400, scanning signals Gk (k=1 to p) such as those described below are outputted from a gate output unit 47 in each gate driver IC chip. Note that the logical values of the scanning signals Gk are represented by a logical expression shown in the following equation (1):

Gk=((((Qk−1 and Qk) or (Qk and Qk+1)) and (not GOE)) or (((Qk−1 and Qk) nor (Qk and Qk+1)) and (not GCK))) and Qk (1).

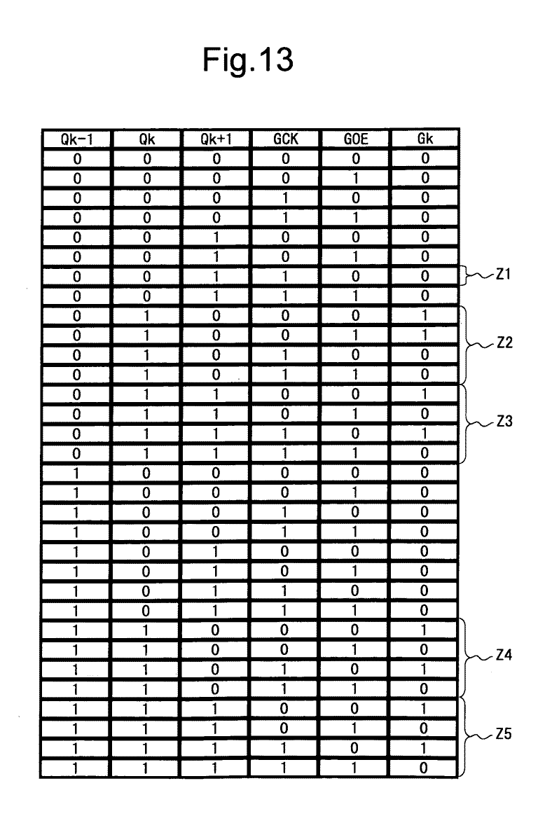

FIG. 13 is a diagram for describing a scanning signal Gk which is outputted based on an output signal Qk from a kth stage of a shift register 40 in each gate driver IC chip. As can be grasped from the above equation (1), the logical level of the scanning signal Gk is determined based on logical levels of an output signal Qk−1 from a (k−1)th stage of the shift register 40, an output signal Qk from a kth stage, an output signal Qk+1 from a (k+1)th stage, a gate output control signal GOE, and a gate clock signal GCK. FIG. 13 shows a correspondence relationship between the logical levels of the signals Qk−1, Qk, Qk+1, GOE, and GCK and the logical level of the scanning signal Gk. Note that in FIG. 13 “0” indicates that the logical level is a low level and “1” indicates that the logical level is a high level. For example, a row denoted by reference numeral Z1 in FIG. 13 shows that if “the output signal Qk-1 is at a low level”, “the output signal Qk is at a low level”, “the output signal Qk+1 is at a high level”, “the gate clock signal GCK is at a high level”, and “the gate output control signal GOE is at a low level”, then “the scanning signal Gk is at a low level”.

The following can be grasped from FIG. 13. When the output signal Qk is at a low level, the scanning signal Gk does not go to a high level. When “the output signal Qk−1 is at a low level”, “the output signal Qk is at a high level”, and “the output signal Qk+1 is at a low level”, if the gate clock signal GCK is at a low level then the scanning signal Gk is at a high level and if the gate clock signal GCK is at a high level then the scanning signal Gk is at a low level (see rows denoted by reference numeral Z2). When “the output signal Qk-1 is at a low level”, “the output signal Qk is at a high level”, and “the output signal Qk+1 is at a high level”, if the gate output control signal GOE is at a low level then the scanning signal Gk is at a high level and if the gate output control signal GOE is at a high level then the scanning signal Gk is at a low level (see rows denoted by reference numeral Z3). When “the output signal Qk−1 is at a high level”, “the output signal Qk is at a high level”, and “the output signal Qk+1 is at a low level”, if the gate output control signal GOE is at a low level then the scanning signal Gk is at a high level and if the gate output control signal GOE is at a high level then the scanning signal Gk is at a low level (see rows denoted by reference numeral Z4). When “the output signal Qk−1 is at a high level”, “the output signal Qk is at a high level”, and “the output signal Qk+1 is at a high level”, if the gate output control signal GOE is at a low level then the scanning signal Gk is at a high level and if the gate output control signal GOE is at a high level then the scanning signal Gk is at a low level (see rows denoted by reference numeral Z5).

Here, the rows denoted by reference numeral Z2 in FIG. 13 show the logical values of the respective signals for when the pulse width of the start pulse signal SPi is a width substantially corresponding to one horizontal scanning period (1H). Also, the rows denoted by reference numerals Z3, Z4, and Z5 in FIG. 13 show the logical values of the respective signals for when the pulse width of the start pulse signal SPi is a width substantially corresponding to a period of two horizontal scanning periods (2H) or more. That is, at the time when a (normal) pixel data write is performed, the scanning signal Gk is at a high level during a period, where the gate clock signal GCK is at a low level, of a period, where the output signal Qk is at a high level. Also, at the time when black insertion (application of a black voltage) is performed, the scanning signal Gk is at a high level during a period, where the gate output control signal GOE is at a low level, of a period, where the output signal Qk is at a high level.

<5. Actions and Effects>

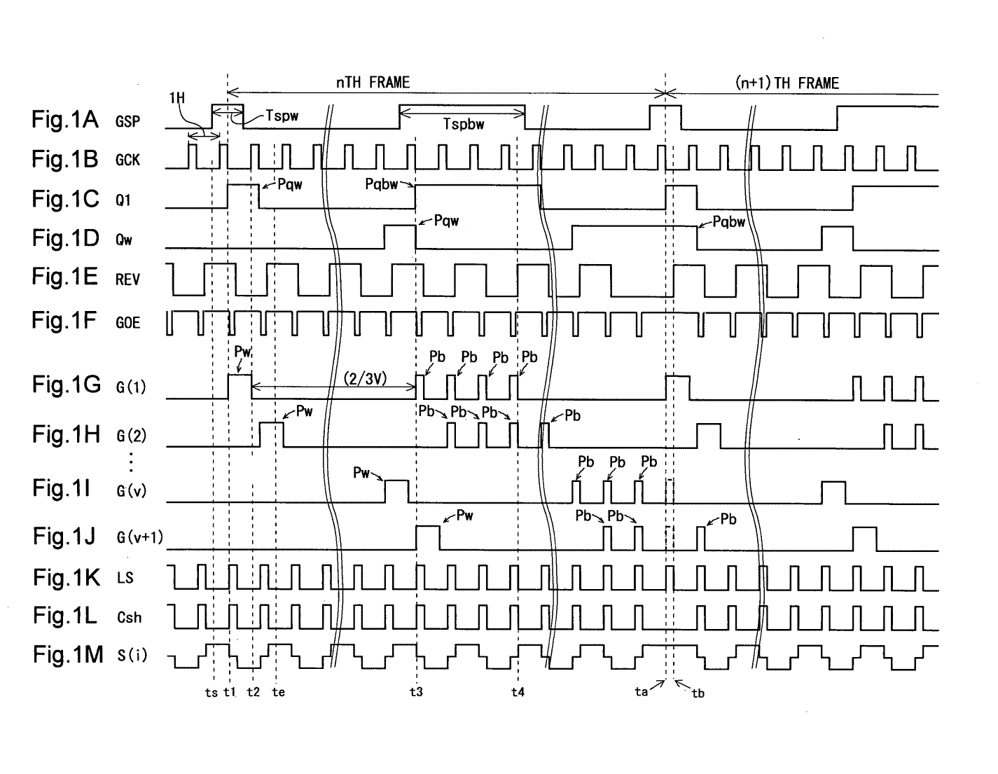

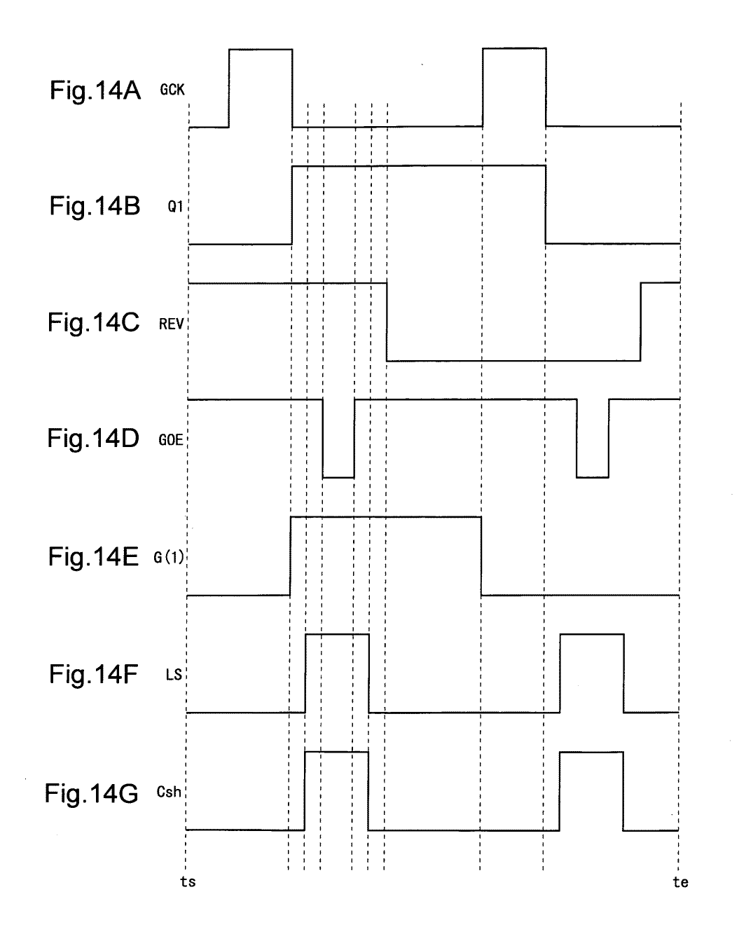

Actions and effects in the present embodiment will be described below. FIGS. 1A to 1M and FIGS. 14A to 14G are signal waveform diagrams for describing actions in the present embodiment. FIGS. 1A to 1M respectively show the waveforms of a gate start pulse signal GSP, a gate clock signal GCK, an output signal Q1 corresponding to a scanning signal G(1) (an output signal from the first stage of the shift register 40 in the gate driver IC chip 411), an output signal Qw corresponding to a scanning signal G(v), a polarity control signal REV, a gate output control signal GOE, the scanning signal G(1), a scanning signal G(2), the scanning signal G(v), a scanning signal G(v+1), a latch strobe signal LS, a short circuit control signal Csh, and a data signal S(i) which is applied to a source bus line of an ith column. Also, FIGS. 14A to 14G respectively show the detailed waveforms of the gate clock signal GCK, the output signal Q1, the polarity control signal REV, the gate output control signal GOE, the scanning signal G(1), the latch strobe signal LS, and the short circuit control signal Csh during a period from time point is to time point to in FIGS. 1A to 1M. Note that here it is assumed that the fourth black voltage application pulse Pb for the scanning signal G(v) which is applied to a gate bus line of a with row is conventionally generated during a period immediately after the timing at which switching between frame periods is performed (a period from time point ta to time point tb). Note also that it is assumed that the scanning signal G(v) is generated based on the output signal Qw.

The display control circuit 200 generates, as shown in FIG. 1A, as a gate start pulse signal GSP, a signal that is at a high level only for a period Tspw for a pixel data write pulse Pw and a period Tspbw for four black voltage application pulses Pb, and generates, as shown in FIG. 1B, a gate clock signal GCK that is at a high level every horizontal scanning period (1H) only for a predetermined period. When such a gate start pulse signal GSP and a gate clock signal GCK are inputted into the gate driver 400 shown in FIG. 10 and FIG. 11, a signal such as that shown in FIG. 1C is outputted as an output signal Q1 of the first stage of the shift resistor 40 in the first gate driver IC chip 411. The output signal Q1 includes, in each frame period, one pulse Pqw corresponding to the pixel data write pulse Pw and one pulse Pqbw corresponding to the four black voltage application pulses Pb. The pulse Pqw and the pulse Pqbw are separated by substantially a (⅔) frame period. Such two pulses Pqw and Pqbw are sequentially transferred to the coupled shift registers in the gate driver 400, based on the pulses of the gate clock signal GCK. Correspondingly, signals having the same waveform as that shown in FIG. 1C are sequentially outputted from the respective stages of the coupled shift registers, with a time lag of one horizontal scanning period (1H). By this, an output signal Qw having a waveform such as that shown in FIG. 1D is outputted as a signal corresponding to the scanning signal G(v). Note that in the present embodiment the period Tspw corresponds to a first pulse width and the period Tspbw corresponds to a second pulse width.

In addition, the display control circuit 200 generates a gate output control signal (pre-adjustment gate output control signal) GOEpre for controlling the operation of the gate driver 400. As for the pre-adjustment gate output control signal GOEpre, as described above, a waveform adjustment is performed in the gate output control signal waveform adjustment circuit 500, based on a polarity control signal REV having a waveform such as that shown in FIG. 1E. By this, a gate output control signal GOE having a waveform such as that shown in FIG. 1F is inputted into the gate driver 400. Namely, the gate output control signal GOE that is maintained at a high level during a period before and after switching between frame periods is performed (a period from time points ta to tb) and that is at a low level only for a predetermined period every horizontal scanning period during other periods is inputted into the gate driver 400.

In each gate driver IC chip 41r (r=1 to q) having the configuration shown in FIG. 11, scanning signals G1 to Gp to be applied to gate bus lines are generated based on output signals Qk (k=1 to p) from the respective stages (from the first stage to a pth stage) of a shift register 40, a gate clock signal GCK, and a gate output control signal GOE. As described above, during a period for performing a (normal) pixel data write, i.e., a period during which the above-described pulse Pqw is generated in the output signal Qk, the scanning signals G1 to Gp are at a high level during a period, where the gate clock signal GCK is at a low level, of a period, where the output signal Qk is at a high level. Also, as described above, during a period for performing black insertion (black voltage application), i.e., a period during which the above-described pulse Pqbw is generated in the output signal Qk, the scanning signals G1 to Gp are at a high level during a period, where the gate output control signal GOE is at a low level, of a period, where the output signal Qk is at a high level. By this, scanning signals G(1), G(2), G(v), and G(v+1) having waveforms such as those shown in FIGS. 1G to 1J, for example, are outputted to gate bus lines from the gate driver 400.

Here, when taking a look at the period immediately after switching between frame periods is performed (the period from time point ta to time point tb), the fourth black voltage application pulse for the scanning signal G(v) which is conventionally generated is not generated (see FIG. 1I). In addition, during such a period, the third black voltage application pulse for the scanning signal G(v+1) (see FIG. 1J), the second black voltage application pulse for a scanning signal G(v+2) (not shown), and the first black voltage application pulse for a scanning signal G(v+3) (not shown) are not generated either.

Also, in the short circuit control signal generating unit 304 in the source driver 300, a short circuit control signal Csh is generated in the above-described manner, based on the polarity control signal REV having a waveform such as that shown in FIG. 1E and a latch strobe signal LS having a waveform such as that shown in FIG. 1K. By this, the waveform of the short circuit control signal Csh is such as that shown in FIG. 1L. Then, since adjacent source bus lines are short-circuited based on the short circuit control signal Csh, the waveform of a data signal S(i) which is applied to a source bus line SLi of an ith column is such as that shown in FIG. 1M. As can be grasped from FIG. 1M, during the period immediately after switching between frame periods is performed (the period from time point ta to time point tb), charge sharing is not performed and a black voltage is not applied to each of the source bus lines SL1 to SLn.

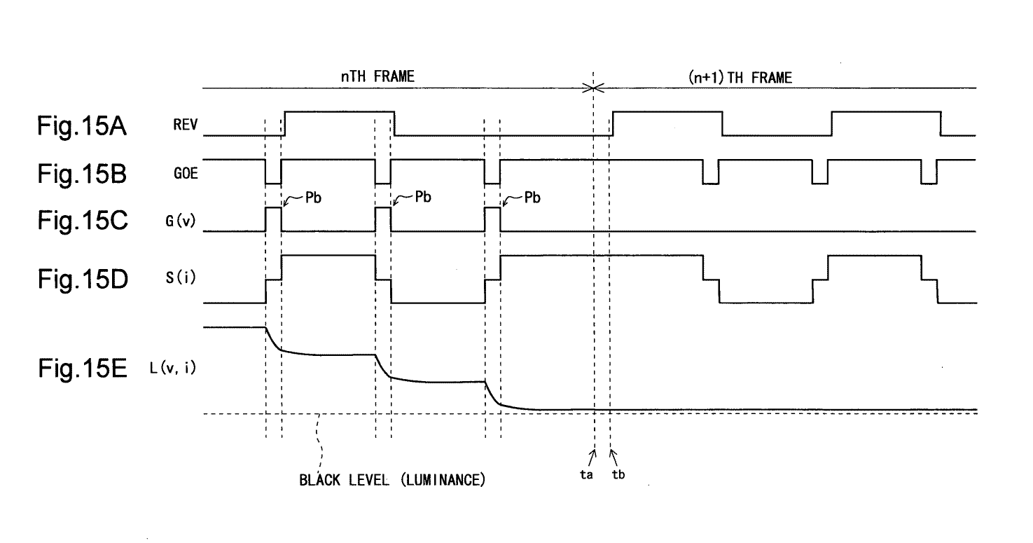

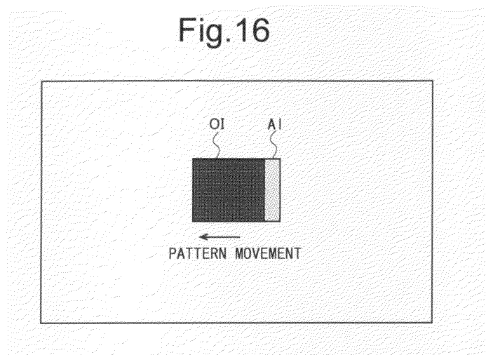

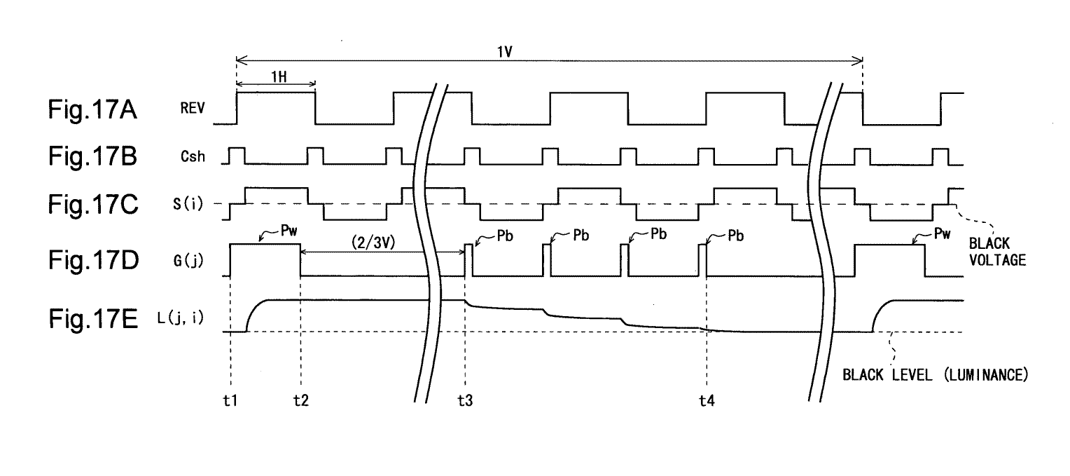

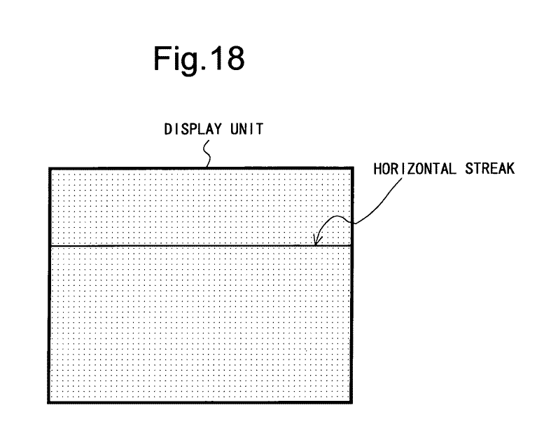

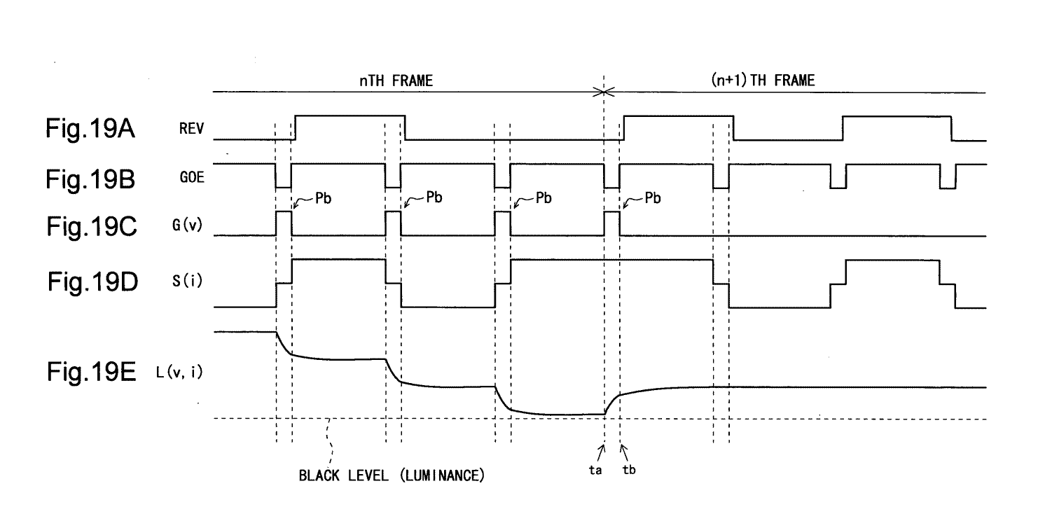

Next, effects in the present embodiment will be described with reference to FIGS. 15A to 15E and FIGS. 19A to 19E. Note that FIGS. 15A to 15E are signal waveform diagrams in the present embodiment and FIGS. 19A to 19E are signal waveform diagrams in a conventional example. In the conventional example, as shown in FIG. 19B, a gate output control signal GOE is brought to a low level during a period immediately after switching between frame periods is performed (a period from time point ta to time point tb). Hence, during such a period, despite the fact that, as shown in FIG. 19D, the voltage of a source bus line is not a black voltage, as shown in FIG. 19C, a black voltage application pulse Pb for a scanning signal G(v) is generated. By this, in a pixel formation portion on which a black voltage write is to be performed, luminance increases, as shown in FIG. 19E.

On the other hand, according to the present embodiment, as shown in FIG. 15B, a gate output control signal GOE is maintained at a high level during a period immediately after switching between frame periods is performed (a period from time point ta to time point tb). Hence, during such a period, as shown in FIG. 15C, a black voltage application pulse Pb for a scanning signal G(v) is not generated. By this, during such a period, in a pixel formation portion on which a black voltage write is to be performed, a write based on a data signal S(i) is not performed. Accordingly, as shown in FIG. 15E, in a period before and after switching between frame periods is performed, the luminance of a pixel formation portion arranged in a with row and an ith column is maintained at a luminance close to the black level. As a result, the occurrence of a horizontal streak on a screen is prevented which occurs due to the polarity of a polarity control signal REV not changing during two consecutive horizontal scanning periods near the timing at which switching between frame periods is performed.

In addition, in the present embodiment, as shown in FIG. 1A, the gate start pulse signal GSP includes pulses having the pulse width Tspbw corresponding to four black voltage application pulses Pb. Hence, even if a black voltage application pulse is not generated which is conventionally generated during a period immediately after switching between frame periods is performed, at least three black voltage application pulses are generated for each scanning signal. By this, a black voltage write to a pixel capacitance in each pixel formation portion is performed at least three times in each frame period. Accordingly, an insufficient black voltage write to a pixel capacitance in each pixel formation portion does not occur.

<6. Others>

Although in the above-described embodiment four black voltage application pulses Pb are applied to each gate bus line GLj every frame period, the number of black voltage application pulses Pb during one frame period is not limited to four. The number of black voltage application pulses Pb can be any number Z as long as display can be sufficiently brought to the black level by application of a black voltage (Z−1) times. Note that the number of black voltage application pulses Pb during one frame period can be easily adjusted by changing the setting of the period Tspbw in the gate start pulse signal GSP (see FIG. 1A).

In addition, although in the above-described embodiment a black voltage application pulse Pb is applied to each gate bus line GLj at the time when a (⅔) frame period has elapsed since a pixel data write pulse Pw is applied to the gate bus line GLj (see FIG. 3D) and black insertion is performed for substantially a (⅓) frame period for each frame period, the black display period is not limited to a (⅓) frame period. Note that if the black display period is lengthened, then the effect of implementation of impulse is increased and thus display quality at the time of moving image display is improved, but display luminance decreases. Hence, the black display period is set taking into account the effect of implementation of impulse and display luminance.

1. An active matrix-type display device comprising:
a plurality of data signal lines for transmitting a plurality of data signals representing an image to be displayed;
a plurality of scanning signal lines intersecting the plurality of data signal lines;
a plurality of pixel formation portions arranged in a matrix form at respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected;
a data signal line drive circuit that receives a latch signal including pulses, each generated every horizontal scanning period, and a polarity control signal for determining a polarity of each data signal, and applies the plurality of data signals to the plurality of data signal lines such that the polarity of each data signal is reversed every predetermined cycle in each frame period, based on a logical level of the polarity control signal obtained at a time of a rise or a fall of a pulse of the latch signal;
a black voltage insertion circuit that brings voltages of the plurality of data signal lines to a voltage corresponding to black display only for a predetermined black voltage insertion period when polarities of the plurality of data signals are reversed, based on the latch signal and the polarity control signal, the black voltage insertion circuit being provided inside or external to the data signal line drive circuit;
a scanning signal line drive circuit that places each scanning signal line in a selected state, based on a predetermined output control signal which changes between a first logical level and a second logical level substantially in synchronization with timing of a rise and a fall of the pulses of the latch signal; and
an output control signal generation circuit for generating the output control signal, wherein
the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display,
during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal generation circuit maintains the output control signal at the first logical level during the subsequent horizontal scanning period, and
the scanning signal line drive circuit:
places each scanning signal line in the first selected state at least once in each frame period and places each scanning signal line in the second selected state a plurality of times in each frame period; and
does not place any of the plurality of scanning signal lines in the second selected state if the output control signal is at the first logical level.

2. The display device according to claim 1, wherein
the data signal line drive circuit applies the plurality of data signals to the plurality of data signal lines such that polarities of data signals applied to adjacent data signal lines, respectively, differ from each other, and
the black voltage insertion circuit brings the voltages of the plurality of data signal lines to a voltage corresponding to black display by short-circuiting the adjacent data signal lines.

3. The display device according to claim 1, wherein
the scanning signal line drive circuit receives a start pulse signal including: a first pulse having a first pulse width corresponding to a period for allowing each pixel formation portion to capture a voltage corresponding to the image to be displayed; and a second pulse having a second pulse width corresponding to a period for allowing each pixel formation portion to capture a voltage corresponding to the black display, and places each scanning signal line in the second selected state based on the second pulse of the start pulse signal and the output control signal, and
the second pulse width is a period corresponding to at least four horizontal scanning periods.

4. The display device according to claim 3, wherein the scanning signal line drive circuit further receives a clock signal including pulses, each generated every horizontal scanning period, and places each scanning signal line in the first selected state based on the first pulse of the start pulse signal and the pulses of the clock signal.

5. A drive circuit for an active matrix-type display device including a plurality of data signal lines for transmitting a plurality of data signals representing an image to be displayed; a plurality of scanning signal lines intersecting the plurality of data signal lines; and a plurality of pixel formation portions arranged in a matrix form at respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected, the drive circuit comprising:
a data signal line drive circuit that receives a latch signal including pulses, each generated every horizontal scanning period, and a polarity control signal for determining a polarity of each data signal, and applies the plurality of data signals to the plurality of data signal lines such that the polarity of each data signal is reversed every predetermined cycle in each frame period, based on a logical level of the polarity control signal obtained at a time of a rise or a fall of a pulse of the latch signal;
a black voltage insertion circuit that brings voltages of the plurality of data signal lines to a voltage corresponding to black display only for a predetermined black voltage insertion period when polarities of the plurality of data signals are reversed, based on the latch signal and the polarity control signal, the black voltage insertion circuit being provided inside or external to the data signal line drive circuit;
a scanning signal line drive circuit that places each scanning signal line in a selected state, based on a predetermined output control signal which changes between a first logical level and a second logical level substantially in synchronization with timing of a rise and a fall of the pulses of the latch signal; and
an output control signal generation circuit for generating the output control signal, wherein
the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display, during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal generation circuit maintains the output control signal at the first logical level during the subsequent horizontal scanning period, and
the scanning signal line drive circuit:
places each scanning signal line in the first selected state at least once in each frame period and places each scanning signal line in the second selected state a plurality of times in each frame period; and
does not place any of the plurality of scanning signal lines in the second selected state if the output control signal is at the first logical level.

6. The drive circuit according to claim 5, wherein
the data signal line drive circuit applies the plurality of data signals to the plurality of data signal lines such that polarities of data signals applied to adjacent data signal lines, respectively, differ from each other, and
the black voltage insertion circuit brings the voltages of the plurality of data signal lines to a voltage corresponding to black display by short-circuiting the adjacent data signal lines.

7. The drive circuit according to claim 5, wherein
the scanning signal line drive circuit receives a start pulse signal including: a first pulse having a first pulse width corresponding to a period for allowing each pixel formation portion to capture a voltage corresponding to the image to be displayed; and a second pulse having a second pulse width corresponding to a period for allowing each pixel formation portion to capture a voltage corresponding to the black display, and places each scanning signal line in the second selected state based on the second pulse of the start pulse signal and the output control signal, and
the second pulse width is a period corresponding to at least four horizontal scanning periods.

8. The drive circuit according to claim 7, wherein the scanning signal line drive circuit further receives a clock signal including pulses, each generated every horizontal scanning period, and places each scanning signal line in the first selected state based on the first pulse of the start pulse signal and the pulses of the clock signal.

9. A drive method for an active matrix-type display device including a plurality of data signal lines for transmitting a plurality of data signals representing an image to be displayed; a plurality of scanning signal lines intersecting the plurality of data signal lines; and a plurality of pixel formation portions arranged in a matrix form at respective intersections of the plurality of data signal lines and the plurality of scanning signal lines, each pixel formation portion capturing, as a pixel value, a voltage of a data signal line passing through a corresponding intersection, when a scanning signal line passing through the corresponding intersection is selected, the drive method comprising:
a data signal line driving step of receiving a latch signal including pulses, each generated every horizontal scanning period, and a polarity control signal for determining a polarity of each data signal, and applying the plurality of data signals to the plurality of data signal lines such that the polarity of each data signal is reversed every predetermined cycle in each frame period, based on a logical level of the polarity control signal obtained at a time of a rise or a fall of a pulse of the latch signal;
a black voltage inserting step of bringing voltages of the plurality of data signal lines to a voltage corresponding to black display only for a predetermined black voltage insertion period when polarities of the plurality of data signals are reversed, based on the latch signal and the polarity control signal;
a scanning signal line driving step of placing each scanning signal line in a selected state, based on a predetermined output control signal which changes between a first logical level and a second logical level substantially in synchronization with timing of a rise and a fall of the pulses of the latch signal; and
an output control signal generating step of generating the output control signal, wherein
the selected state of each scanning signal line includes a first selected state and a second selected state, the first selected state being a selected state for allowing each pixel formation portion to capture a voltage corresponding to the image to be displayed and the second selected state being a selected state for allowing each pixel formation portion to capture a voltage corresponding to the black display,
in the output control signal generating step, during any two consecutive horizontal scanning periods including a previous horizontal scanning period and a subsequent horizontal scanning period, if a logical level of the polarity control signal during the previous horizontal scanning period is same as a logical level of the polarity control signal during the subsequent horizontal scanning period, then the output control signal is maintained at the first logical level during the subsequent horizontal scanning period, and
in the scanning signal line driving step:
each scanning signal line is placed in the first selected state at least once in each frame period and each scanning signal line is placed in the second selected state a plurality of times in each frame period; and
none of the plurality of scanning signal lines is placed in the second selected state if the output control signal is at the first logical level.

10. The drive method according to claim 9, wherein
in the data signal line driving step, the plurality of data signals are applied to the plurality of data signal lines such that polarities of data signals applied to adjacent data signal lines, respectively, differ from each other, and
in the black voltage inserting step, the voltages of the plurality of data signal lines are brought to a voltage corresponding to black display by short-circuiting the adjacent data signal lines.

11. The drive method according to claim 9, wherein
in the scanning signal line driving step, a start pulse signal is obtained which includes: a first pulse having a first pulse width corresponding to a period for allowing each pixel formation portion to capture a voltage corresponding to the image to be displayed; and a second pulse having a second pulse width corresponding to a period for allowing each pixel formation portion to capture a voltage corresponding to the black display, and each scanning signal line is placed in the second selected state based on the second pulse of the start pulse signal and the output control signal, and
the second pulse width is a period corresponding to at least four horizontal scanning periods.

12. The drive method according to claim 11, wherein in the scanning signal line driving step, a clock signal including pulses, each generated every horizontal scanning period, is further obtained, and each scanning signal line is placed in the first selected state based on the first pulse of the start pulse signal and the pulses of the clock signal.
